(19) United States
(12) Patent Application Publication
(10) Pub. No.: US 2008/0084849 A1
(43) Pub. Date: Apr. 10, 2008

(54) AUTONOMOUS TIMING ADVANCE ADJUSTMENT DURING HANDOVER

(75) Inventors: Jin Wang, Central Islip, NY (US); Stephen E. Terry, Northport, NY (US); Arty Chandra, Manhasset Hills, NY (US); Allan Yingming Tsai, Boonton, NJ (US); Donald M. Grieco, Manhasset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/867,414

(22) Filed: Oct. 4, 2007

Related U.S. Application Data
(60) Provisional application No. 60/828,437, filed on Oct. 6, 2006.

(51) Int. Cl. H04Q 7/00

(52) U.S. Cl. 370/332

(57) ABSTRACT

A method and apparatus for uplink synchronization during handover are disclosed. A wireless transmit/receive unit (WTRU) measures a downlink receipt timing difference between a source Node-B and a target Node-B. The WTRU calculates a target Node-B timing advance value based on the downlink receipt timing difference, a source Node-B timing advance value, and a relative downlink transmit timing difference between the target Node-B and the source Node-B. The WTRU then applies the target Node-B timing advance value in transmission to the target Node-B. The source Node-B may calculate the relative downlink transmit timing difference between the target Node-B and the source Node-B, and send it to the WTRU. The source Node-B may provide the source Node-B timing advance value more frequently during handover. The WTRU may measure the downlink receipt timing difference by averaging multiple first significant paths (FSPs) over a certain time window.

### CROSS REFERENCE TO RELATED APPLICATION

This application claims the benefit of U.S. provisional application No. 60/828,437 filed Oct. 6, 2006, which is incorporated by reference as if fully set forth.

### FIELD OF INVENTION

The present invention is related to wireless communications.

### BACKGROUND

The objects of evolved universal terrestrial radio access (E-UTRA) and evolved universal terrestrial radio access network (E-UTRAN) are providing a high-data-rate, low-latency, packet-optimized system with improved system capacity and coverage. In order to achieve these objects, long term evolution (LTE) of the third generation (3G) wireless communication systems is being considered. In 3G LTE, instead of using code division multiple access (CDMA), orthogonal frequency division multiple access (OFDMA) and single carrier frequency division multiple access (SC-FDMA) are proposed air interface technologies to be used in the downlink and uplink transmissions, respectively. One big change in the LTE system is that no dedicated channel is allocated to wireless transmit/receive units (WTRUs) and all services are provided through shared channels. This brings important issues in synchronous transmission in the LTE system during handover.

In order for a Node-B to properly decode uplink transmissions from a plurality of WTRUs, uplink synchronization should be maintained. For uplink synchronization, the Node-B signals each of the WTRUs a timing advance value so that each WTRU applies the signaled timing advance value in uplink transmission. By applying the timing advance values at the WTRUs, the uplink transmissions from the WTRUs are received by the Node-B within a time window that allows accurate detection of the uplink transmissions and minimizes or eliminates signal degradation. SC-FDMA has a very high requirement for uplink synchronization to achieve the necessary performance. Appropriate and accurate timing advance adjustment is very critical to maintain high performance in LTE uplink transmission.

The uplink synchronization should also be maintained during and after handover from a source Node-B to a target Node-B. In a pre-LTE system, this can be achieved through system frame number (SFN)-SFN measurement of dedicated channels from the source and target Node-Bs. However, in the LTE system where no dedicated channels are allocated to the WTRUs, the WTRU must use a different approach to realize timing advance value adjustment during handover.

A straightforward way is to use an asynchronous random access burst to establish the timing advance value. However, asynchronous random access channel (RACH) will cause unacceptable delay for certain applications, such as voice over Internet protocol (VoIP) application. With this problem, a non-contention-based synchronized RACH procedure has been proposed.

Therefore, it would be desirable to provide a method for uplink synchronization during handover with reduced delay.

### SUMMARY

A method and apparatus for uplink synchronization during handover are disclosed. A WTRU measures a downlink receipt timing difference between a source Node-B and a target Node-B. The WTRU calculates a target Node-B timing advance value based on the downlink receipt timing difference, a source Node-B timing advance value, and a relative downlink transmit timing difference between the target Node-B and the source Node-B. The WTRU then applies the target Node-B timing advance value in uplink transmission to the target Node-B. The source Node-B may calculate the relative downlink transmit timing difference between the target Node-B and the source Node-B, and send it to the WTRU. The source Node-B may provide the source Node-B timing advance value more frequently during handover. The WTRU may measure the downlink receipt timing difference by averaging multiple first significant paths (FSPs) over a certain time window.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows an example wireless communication system;

FIG. 2 is a block diagram of an example WTRU in accordance with the present invention; and

FIG. 3 shows timing relationship among a downlink transmit timing, downlink propagation delay, and detection of FSP.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, an evolved Node-B, a site controller, an access point (AP), or any other type of interfacing device capable of operating in a wireless environment.

The present invention may be applied to any wireless communication systems including, but not limited to, third generation partnership project (3GPP) LTE, 3GPP high speed packet access (HSPA), frequency division duplex (FDD), time division duplex (TDD), time division synchronous CDMA (TDSCDMA), CDMA2000, OFDMA, SC-FDMA, or any other type of wireless communication systems. The present invention may be implemented at the physical Layer (L1), digital baseband, data link layer (L2), network layer (L3), and the like.

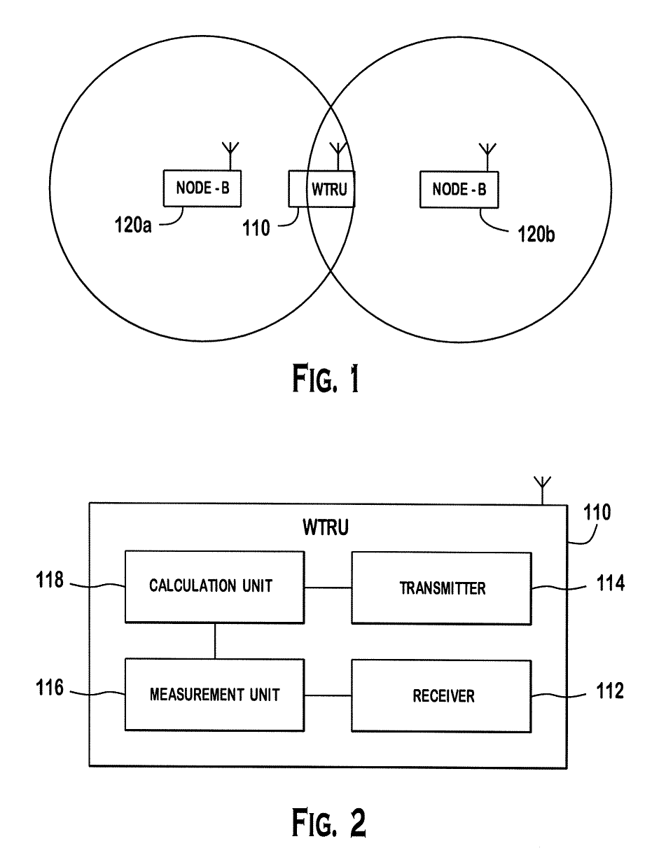

FIG. 1 shows an example wireless communication system 100. The system 100 may include a WTRU 110 and a plurality of Node-Bs 120a, 120b. FIG. 1 shows only one WTRU 110 and two Node-Bs 120a, 120b for simplicity, but the system 100 may include any number of WTRUs and any number of Node-Bs. The WTRU 110 is originally connected to a source Node-B 120a. As the WTRU crosses the boundary of the coverage area of the source Node-B 120a, a handover to the target Node-B 120b is initiated.

At all times other than handover, the source Node-B 120a, (or any other network entity), measures and estimates the uplink transmission of the WTRU 110 to determine the timing advance value with respect to the source Node-B 120a for uplink synchronization at the source Node-B 120a, and signals the timing advance value to the WTRU 110. During handover from the source Node-B 120a to the target Node-B 120b, the WTRU 110 autonomously calculates, and adjusts, the timing advance value with respect to the target Node-B 120b to eliminate the timing drift at the target Node-B 120b.

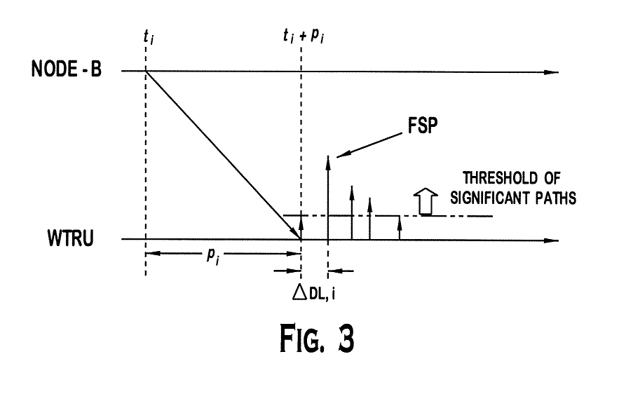

FIG. 2 is a block diagram of an example WTRU 110 in accordance with the present invention. The WTRU 110 may comprise a receiver 112, a transmitter 114, a measurement unit 116, and a calculation unit 118. It should be noted that the WTRU 110 may further include any processing components that are necessary for the conventional wireless communications. The receiver 112 receives signals, (e.g., beacon channel signals, such as broadcast channel or reference (pilot) channel, etc.), from the source Node-B 120a and the target Node-B 120b. The measurement unit 116 measures a downlink receipt timing difference (ΔTₘₑₐₛ) between the source Node-B 120a and the target Node-B 120b based on the received signals. The calculation unit 118 calculates the timing advance value (TAⱼ) with respect to the target Node-B 120b based on the downlink receipt timing difference (ΔTₘₑₐₛ), a timing advance value (TAᵢ) with respect to the source Node-B 120a, and a relative downlink transmit timing difference (tⱼ−tᵢ) between the source Node-B 120a and the target Node-B 120b.

The timing advance value to be applied to the target Node-B 120b is calculated as follows:
TAⱼ=TAᵢ+2(ΔTₘₑₐₛ−(tⱼ−tᵢ)); Equation (1)
where tᵢ denotes the transmission timing at the source Node-B 120a, and tᵢ denotes the transmission timing at the target Node-B 120b.

The transmitter 114 then transmits a signal to the target Node-B 120b applying the calculated timing advance value (TAⱼ). The WTRU 110 may use an assigned uplink channel with timing advance applied for direct transmission. This uplink channel may be allocated before the handover. For example, the allocation may be included in the handover command, or the source and target Node-Bs may exchange the channel allocation and assign it to the WTRU to apply it starting from a certain time. Alternatively, the WTRU 110 may use the synchronous RACH for resource request and then start data transmission after resource allocation from the target Node-B 120b.

According to Equation (1), the timing advance value (TAⱼ) to the target Node-B 120b depends on the timing advance value (TAᵢ) to the source Node-B 120a. Therefore, the accuracy of the timing advance value to the source Node-B 120a is important to guarantee the accuracy of the timing advance value to be applied to the target Node-B 120b. Due to WTRU mobility during handover, the source Node-B timing advance value (TAᵢ) may vary.

The source Node-B 120a, (or any other network entity), may continuously measure the uplink transmissions of the WTRU 110 and make the source Node-B timing advance value (TAᵢ) estimation and send it to the WTRU 110. During handover, the source Node-B 120a may make the TAᵢ value estimation more frequently compared to the non-handover case in order to assure the accuracy of the TAᵢ value.

The source Node-B 120a may send the source Node-B timing advance value (TAᵢ) at time tᵢ before handover so that the TAᵢ value is received and processed by the WTRU 110 on time, where the timing tᵢ guarantees the following:
tᵢ+pᵢ+Δ_{DL,i}+εᵢ=t_{HO}; Equation (2)
where pᵢ is the propagation delay, Δ_{DL,i} is the difference between the first physical signal path and the first significant path (FSP) with respect to the source Node-B, ε_{,i} is the WTRU processing delay, and t_{HO} is the handover moment. FIG. 3 shows this timing relationship.

The source Node-B timing advance value TAᵢ may be included in the handover command if its transmission timing meets the requirement of Equation (2). More generally, the timing advance value TAᵢ may be included in any message meeting the timing requirement of Equation (2).

The source Node-B timing advance value (TAᵢ) may be transmitted as a radio resource control (RRC) or medium access control (MAC) message, (e.g., using a MAC control PDU). To achieve the fast delivery of the timing advance value, the timing advance value may be transmitted using L1 control signaling from the source Node-B 120a. To make a reliable transmission of the timing advance value, a more robust modulation and coding scheme (MCS) and/or cyclic redundancy check (CRC) may be used.

When the source Node-B 120a and the target Node-B 120b are not synchronized, the relative transmit timing difference (tⱼ−tᵢ) between the source Node-B 120a and the target Node-B 120b should be estimated. The source Node-B 120a and the target Node-B 120b measure their transmit timings with respect to the WTRU 110, and the target Node-B 120b sends its transmit timing to the source Node-B 120a, (e.g., in the handover response message). The source Node-B 120a, (or any other network entity), then calculates the relative transmit timing difference, (tⱼ−tᵢ), and signals it to the WTRU 110 along with the timing advance value TAᵢ. The relative transmit timing difference value (tⱼ−tᵢ) may be included in the handover command. Alternatively, the relative transmit timing difference value may be sent together with the timing advance value just prior to the handover moment.

When measuring the FSP in order to estimate the channel profile, the FSP may not be the first physical path which is strong enough for detection as shown in FIG. 3. FIG. 3 illustrates the case that the second physical path is the FSP as an example. In accordance with the present invention, an FSP averaging technique may be used to reduce the timing misalignment between the WTRU 110 and the source Node-B 120a and between the WTRU 100 and the target Node-B 120b.

The maximum timing misalignment after applying timing advance adjustment to the target Node-B 120b during handover is as follows:
|T_{M,j}|ₘₐₓ≦|ε_{f,j}|ₘₐₓ+|ε_{T,j}|ₘₐₓ+|Δ_{DL,i}−Δ_{UL,i}|; Equation (3)
where T_{M,j} is the maximum timing misalignment after performing timing advance adjustment to the target Node-B 120b, ε_{f,i} is the timing error produced by the fading profile between the WTRU 110 and the target Node-B 120b, ε_{T,j} is the error produced by timing estimation at the target Node-B 120b (due to limited timing detection granularity) and time offset between oscillators at the WTRU 110 and the target Node-B 120b, Δ_{DL,i} is the downlink FSP estimation timing between the WTRU 110 and the source Node-B 120a, and Δ_{UL,i} is the uplink FSP estimation timing between the WTRU 110 and the target Node-B 120b.

To support an autonomous timing advance by the WTRU 110, it is assumed that:
|Δ_{DL,i}−Δ_{UL,i}|≦Margin. Equation (4)

For example, the margin may be 1 μs. The timing misalignment caused by the WTRU autonomous timing advance may fall within the cyclic prefix (CP) length as in the regular timing advance case, and Equation (4) may be rewritten as follows:
|T_{M,j}|ₘₐₓ|≦|ε_{f,j}|ₘₐₓ+|ε_{T,j}|ₘₐₓ+Margin≦T_{CP}. Equation (5)

In order to make |Δ_{DL,i}−Δ_{UL,i}| as small as possible, the FSPs are averaged at the source Node-B 120a and the WTRU 110 for Δ̅_{DL,i}=E{Δ_{DL,i}} and Δ̅_{UL,i}=E{Δ_{UL,i}} respectively, during a certain time window. In that way, the timing estimation error caused by downlink and uplink FSP may be reduced. The estimation error due to FSP then becomes as follows:
Error=| Δ̅_̅{̅D̅L̅,̅i̅}̅− Δ̅_̅{̅U̅L̅,̅i̅}̅; Equation (6)
where Δ̅_̅{̅D̅L̅,̅i̅}̅ and Δ̅_̅{̅U̅L̅,̅i̅}̅ are the downlink and uplink average FSP estimation timing, respectively.

Start timing for FSP estimation at the WTRU 110 and the window size for averaging may be signaled to the WTRU 110 for downlink FSP timing averaging. The window size for downlink and uplink FSP estimation may be adjusted adaptively by reflecting the mobility and fading profile. This time window has to be smaller than certain timing margin due to mobility of the WTRU 110 and greater than the start and stop timing of FSP. The mobility and channel condition information may be sent to the source Node-B 120a to determine the time window and other parameters.

The averaging window size is preferably set long enough to make | Δ̅_̅{̅D̅L̅,̅i̅}̅− Δ̅_̅{̅U̅L̅,̅i̅}̅| within N FSPs which can safely guarantee the following relationship:
| Δ̅_̅{̅D̅L̅,̅i̅}̅− Δ̅_̅{̅U̅L̅,̅i̅}̅|≦Margin. Equation (7)

The margin may be 1 μs, for example. The window size information may be included in the handover command or other downlink message. The window size information may be sent in the broadcast message or as an RRC or MAC message.

Although the features and elements are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of uplink synchronization during handover, the method comprising:
a wireless transmit/receive unit (WTRU) measuring a downlink receipt timing difference between a source Node-B and a target Node-B;
the WTRU calculating a first timing advance value with respect to a target Node-B based on the downlink receipt timing difference, a second timing advance value with respect to the source Node-B, and a downlink transmit timing difference between the target Node-B and the source Node-B; and
the WTRU applying the first timing advance value in transmission to the target Node-B.

2. The method of claim 1 wherein no dedicated channel is allocated to the WTRU.

3. The method of claim 1 wherein the WTRU calculates the downlink transmit timing difference between the target Node-B and the source Node-B.

4. The method of claim 1 wherein the source Node-B calculates the downlink transmit timing difference between the target Node-B and the source Node-B, and sends the downlink transmit timing difference to the WTRU.

5. The method of claim 1 wherein the source Node-B calculates the second timing advance value and sends the second timing advance value to the WTRU more frequently during handover.

6. The method of claim 5 wherein the second timing advance value is included in a handover command sent from the source Node-B to the WTRU.

7. The method of claim 5 wherein the second timing advance value is sent to the WTRU using more reliable modulation and coding scheme (MCS).

8. The method of claim 1 wherein the WTRU measures the downlink receipt timing difference by averaging multiple first significant paths (FSPs) over a certain time window.

9. The method of claim 8 wherein information regarding the window size is included a handover command.

10. The method of claim 8 wherein information regarding the window size is broadcast.

11. The method of claim 8 wherein the window size is adjusted adaptively by reflecting mobility of the WTRU and fading profile.

12. A wireless transmit/receive unit (WTRU) configured to maintain uplink synchronization during handover, the WTRU comprising:
a receiver for receiving signals from a source Node-B and a target Node-B;
a measurement unit for measuring a downlink receipt timing difference between the source Node-B and the target Node-B;
a calculation unit for calculating a first timing advance value with respect to the target Node-B based on the downlink receipt timing difference, a second timing advance value with respect to the source Node-B, and a downlink transmit timing difference between the target Node-B and the source Node-B; and
a transmitter for transmitting a signal to the target Node-B applying the first timing advance value.

13. The WTRU of claim 12 wherein no dedicated channel is allocated to the WTRU.

14. The WTRU of claim 12 wherein the calculation unit calculates the downlink transmit timing difference between the target Node-B and the source Node-B.

15. The WTRU of claim 12 wherein the downlink transmit timing difference between the target Node-B and the source Node-B is calculated by the source Node-B and transmitted to the WTRU.

16. The WTRU of claim 12 wherein the second timing advance value is calculated by the source Node-B and sent to the WTRU more frequently during handover.

17. The WTRU of claim 16 wherein the second timing advance value is included in a handover command sent from the source Node-B to the WTRU.

18. The WTRU of claim 16 wherein the second timing advance value is sent to the WTRU using more reliable modulation and coding scheme (MCS).

19. The WTRU of claim 12 wherein the measurement unit measures the downlink receipt timing difference by averaging multiple first significant paths (FSPs) over a certain time window.

20. The WTRU of claim 19 wherein information regarding the window size is included a handover command.

21. The WTRU of claim 19 wherein the receiver receives information regarding the window size via a broadcast channel.

22. The WTRU of claim 19 wherein the window size is adjusted adaptively by reflecting mobility of the WTRU and fading profile.
